(19) United States
(12) Patent Application Publication
(10) Pub. No.: US 2024/0337026 A1
(43) Pub. Date: Oct. 10, 2024

(54) ULTRA-THIN FILM OF THERMOSETTING RESIN

(71) Applicant: The University of Tokyo, Tokyo (JP)

(72) Inventors: Takuzo AIDA, Tokyo (JP); Yoshimitsu ITOH, Tokyo (JP); Tengfei FU, Tokyo (JP); Pier-Luc CHAMPAGNE, Tokyo (JP); Tsutomu SUZUKI, Tokyo (JP); Atsuteka NAGAO, Tokyo (JP)

(21) Appl. No.: 17/999,838

(22) PCT Filed: May 27, 2021
(86) PCT No.: PCT/JP2021/020178

§ 371 Date: Feb. 13, 2023

(30) Foreign Application Priority Data
May 27, 2020 (JP) 2020-092125

(51) Int. Cl. C25B 3/07; A01N 31/16; A01P 1/00; B01D 71/72; C01B 32/05; C08G 8/22; C08J 5/18

(52) U.S. Cl. CPC C25B 3/07; A01N 31/16; A01P 1/00; B01D 71/72; C01B 32/05; C08G 8/22; C08J 5/18; C08J 2361/12

(57) ABSTRACT

An ultra-thin film of a thermosetting resin, such as a phenolic resin, can be produced by a method that includes introducing a solution containing an aldehyde-based compound and a compound (A) capable of undergoing addition condensation with an aldehyde-based compound into an electrochemical cell, which includes a working electrode and a counter electrode, and applying a positive potential to the working electrode to form a thin film on the working electrode.

### TECHNICAL FIELD

The present invention relates to an ultra-thin film of a thermosetting resin and a method for producing the same. More specifically, the present invention relates to a method for forming an ultra-thin film of a thermosetting resin using an electrode polymerization reaction.

### BACKGROUND ART

A phenolic resin is the first plastic developed over 100 years ago, and is excellent in heat resistance, flame retardancy, and electrical insulation properties. By taking advantage of such properties, the phenolic resin is widely used in an automobile part, a printed board, a photoresist, and the like, which require heat resistance.

A thermosetting resin such as a phenolic resin has a three-dimensional network structure, and thus has an advantage of being resistant to heat or a solvent. On the other hand, since the thermosetting resin is hardly dissolved in a solvent such as an organic solvent, it is difficult to form the thermosetting resin into a thin film. Note that a method in which a phenolic resin (resol) before crosslinking is formed into a film and then cured with an aldehyde is known. In addition, a method for forming a film by forming a composite with another high molecular weight polymer is also known. A film thickness of 1 micrometer or more has been obtained in both the methods, but a nanometer-sized ultra-thin film has not been obtained so far (Patent Literatures 1 and 2).

When a thermosetting resin such as a phenolic resin can be formed into a thin film, a thin film having high mechanical strength can be obtained, and use as a separation film that can be used under a high pressure and a substrate of flexible electronics can be expected. In addition, it can be expected to be used as an antimicrobial/antiviral film derived from a phenol moiety.

### CITATION LIST

### Patent Literatures

Patent Literature 1: JP 61-174235 A
Patent Literature 2: JP 2010-111013 A

### SUMMARY OF INVENTION

### Technical Problem To Be Solved

An objective of the present invention is to provide an ultra-thin film of a thermosetting resin such as a phenolic resin.

### Solution to Problem

The phenolic resin is generally synthesized by addition condensation of a phenolic compound having a phenolic hydroxyl group such as resorcinol and formaldehyde with an aldehyde-based compound such as formaldehyde in the presence of an acid or base catalyst (see FIG. 1). As a result of intensively conducting studies for achieving the above objective, the present inventors have found that when a base catalyst that promotes polymerization can be generated only near a surface of an electrode, a polymerization reaction between a phenolic compound and an aldehyde-based compound proceeds to form a thin film of a phenolic resin, thereby completing the present invention.

That is, the present invention provides the followings.

[1] A method for preparing a thermosetting resin, the method comprising:
providing a solution containing an aldehyde-based compound and a compound (A) capable of undergoing addition condensation with an aldehyde-based compound;
introducing the solution into an electrochemical cell including a working electrode and a counter electrode;
applying a positive potential to the working electrode; and
performing a polymerization reaction on the working electrode

[2] The method according to [1], wherein the compound (A) is at least one compound selected from the group consisting of a phenolic compound, a urea-based compound, and a melamine-based compound.

[3] The method according to [1] or [2], wherein a base is generated near a surface of the working electrode by applying the positive potential to the working electrode.

[4] The method according to any one of [1] to [3], wherein the solution does not contain a supporting electrolyte.

[5] A method for producing an ultra-thin film containing a thermosetting resin, the method comprising: introducing a solution containing an aldehyde-based compound and a compound (A) capable of undergoing addition condensation with an aldehyde-based compound into an electrochemical cell comprising a working electrode and a counter electrode and applying a positive potential to the working electrode to form a thin film on the working electrode.

[6] An ultra-thin film containing a thermosetting resin, in which the ultra-thin film is obtained by performing a polymerization reaction between an aldehyde-based compound and a compound (A) capable of undergoing addition condensation with an aldehyde-based compound.

[7] The ultra-thin film according to [6], in which the ultra-thin film is obtained by applying a positive potential to a working electrode in an electrochemical cell including the working electrode and a counter electrode to perform the polymerization reaction between the aldehyde-based compound and the compound (A) capable of undergoing addition condensation with an aldehyde-based compound on the working electrode.

[8] The ultra-thin film according to [6] or [7], wherein the compound (A) is a phenolic compound.

[9] The ultra-thin film according to any one of [6] to [8], wherein the ultra-thin film has a nanosized thickness.

[10] The ultra-thin film according to [9], wherein the thickness is 10 to 800 nm.

[11] A thermosetting resin obtained by performing a polymerization reaction between an aldehyde-based compound and a compound (A) capable of undergoing addition condensation with an aldehyde-based compound, wherein a density of the thermosetting resin is 0.2 to 0.7 g/cm³, and a Young's modulus of the thermosetting resin is 8 to 20 GPa.

[12] The thermosetting resin according to [11], in which the thermosetting resin has a net-like structure.

[13] The thermosetting resin according to [11] or [12], wherein the compound (A) is a phenolic compound.

[14] An ultra-thin film comprising the thermosetting resin according to any one of [11] to [13].

[15] The ultra-thin film according to [14], wherein the ultra-thin film has a nanosized thickness.

[16] The ultra-thin film according to [15], wherein the thickness is 10 to 300 nm.

[17] A composite thin film comprising the ultra-thin film according to any one of [6] to [10] and [14] to [16], and one or more films selected from the group consisting of a nitrocellulose film, a nylon film, and a Teflon film.

[18] A filtration membrane comprising the ultra-thin film according to any one of [6] to [10] and [14] to [16] or the composite thin film according to [17].

[19] A product for controlling bacteria and/or viruses including the ultra-thin film according to any one of [6] to [10] and [14] to [16] or the composite thin film according to.

[20] A carbonized film obtained by carbonizing the ultra-thin film according to any one of [6] to [10] and [14] to [16].

### Advantageous Effects of Invention

According to the present invention, it is possible to provide an ultra-thin film of a thermosetting resin such as a phenolic resin that has a nanometer-sized thickness.

The ultra-thin film of the phenolic resin of the present invention can be used as a filtration membrane because it has high water permeability and separation ability.

The separation ability of the ultra-thin film of the phenolic resin of the present invention can be adjusted by chemical modification.

In addition, the ultra-thin film of the phenolic resin of the present invention can be applied to a product for controlling bacteria, viruses, or the like because it has a sterilization effect.

In addition, according to the present invention, it is possible to provide an ultra-thin film of a thermosetting resin such as a phenolic resin that has high strength and a mesh-like (net-like) structure.

### BRIEF DESCRIPTION OF DRAWINGS

FIG. 1 is a schematic view of a general method for synthesizing a phenolic resin.

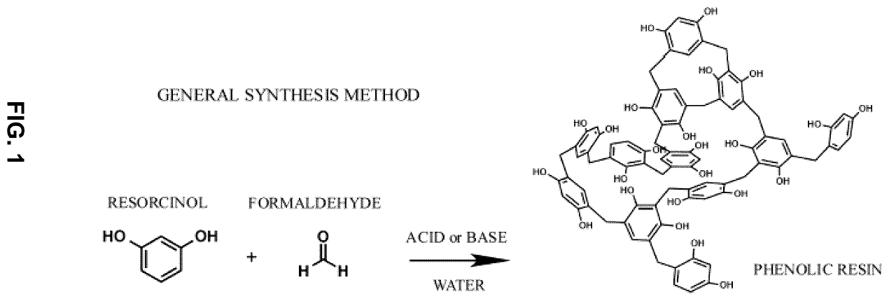

FIG. 2 is a schematic view illustrating an outline of a method for preparing a thermosetting resin of the present invention and a method for producing an ultra-thin film containing a thermosetting resin of the present invention.

FIG. 3 illustrates a photograph of an ultra-thin film obtained in Synthesis Example 1.

FIG. 4 illustrates results of measuring a thickness of the ultra-thin film obtained in Synthesis Example 1 with an atomic force microscope (AFM).

FIG. 5 illustrates results of a permeation experiment of Example 1.

FIG. 6 illustrates results of an antimicrobial/antiviral test of an ultra-thin film in Example 2.

FIG. 7 illustrates results of measuring an XPS spectrum of an ultra-thin film in Example 3.

FIG. 8 illustrates results of measuring nanoindentation of the ultra-thin film in Example 3.

FIG. 9 illustrates results of measuring ¹³CNMR of a thin film synthesized using ¹³C-labeled formaldehyde in Example 3.

FIG. 10 illustrates results of examining a change in thickness of the ultra-thin film depending on a pH in Example 3.

FIG. 11 illustrates results of examining changes in permeation rate of the ultra-thin film and removal rate of a dye (Acid red 88) depending on the pH in Example 3.

FIG. 12 illustrates results of examining reversibility of the permeation rate when the pH is changed from 7→10→7→10 in Example 3.

FIG. 13 illustrates results of measuring a thickness of an ultra-thin film obtained in Synthesis Example 4 with an AFM.

FIG. 14 illustrates results of measuring an XPS spectrum of the ultra-thin film obtained in Example 4.

FIG. 15 illustrates an optical microscopic image of a carbonized film obtained in Example 5.

FIG. 16 illustrates results of measuring a thickness of the carbonized film obtained in Example 5 with an AFM.

FIG. 17 illustrates results of measuring an XPS spectrum of the carbonized film obtained in Example 5.

### DESCRIPTION OF EMBODIMENTS

### 1. Method for Preparing Thermosetting Resin

One embodiment of the present invention is a method for preparing a thermosetting resin (hereinafter, also referred to as a “preparation method of a thermosetting resin of the present invention”), the method comprising: providing a solution containing an aldehyde-based compound and a compound (A) capable of undergoing addition condensation with an aldehyde-based compound; introducing the solution into an electrochemical cell comprising a working electrode and a counter electrode; applying a positive potential to the working electrode; and performing a polymerization reaction on the working electrode.

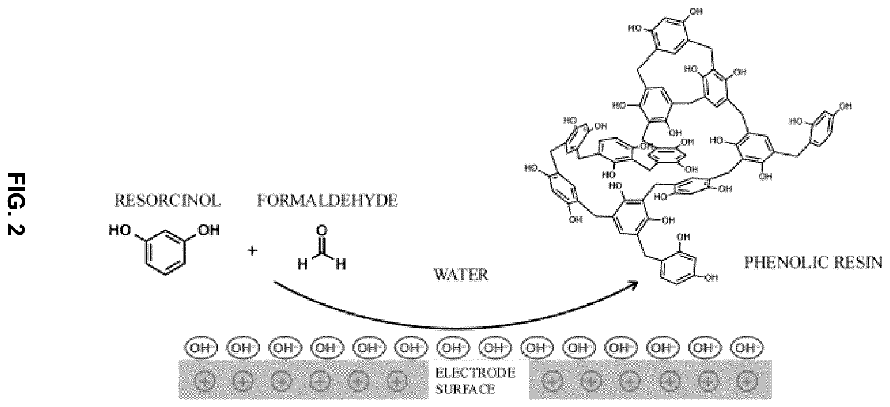

A schematic view illustrating an outline of a method for preparing a thermosetting resin of the present invention and a method for producing an ultra-thin film containing a thermosetting resin of the present invention is illustrated in FIG. 2. While not intending to be bound by theory, in the method for preparing a thermosetting resin of the present invention, a positive potential is applied to a working electrode to generate a base only near a surface of the electrode, such that a polymerization reaction between a compound (A) capable of undergoing addition condensation with an aldehyde-based compound such as formaldehyde and an aldehyde-based compound such as formaldehyde proceeds near the surface, thereby producing a thermosetting resin on the working electrode, more specifically, on the surface of the working electrode.

Hereinafter, the respective constituent requirements in the method for preparing a thermosetting resin of the present invention will be described in detail.

(1) Compound (A) Capable of Undergoing Addition Condensation with Aldehyde-Based Compound

The compound (A) capable of undergoing addition condensation with an aldehyde-based compound (hereinafter, also referred to as a “compound (A)”) is a compound that undergoes a polymerization reaction by addition condensation with an aldehyde-based compound to produce a thermosetting resin.

As the compound (A), a phenolic compound is typical. However, as can be understood from FIG. 2, in the method for preparing a thermosetting resin of the present invention, a base is generated only near the surface of the electrode, such that a polymerization reaction between the compound (A) and the aldehyde-based compound proceeds near the surface. Therefore, a compound capable of undergoing addition condensation with an aldehyde-based compound in the presence of a base catalyst can be used as the compound (A). Examples of such a compound include a urea-based compound and a melamine-based compound.

Therefore, the compound (A) that can be used in the method for preparing a thermosetting resin of the present invention is at least one compound selected from the group consisting of a phenolic compound, a urea-based compound, and a melamine-based compound.

Here, as described below, since the solution containing the aldehyde-based compound and the compound (A) is preferably an aqueous solution, the compound (A) is preferably dissolved in water. From this point of view, a phenolic compound and a urea-based compound are preferable.

The phenolic compound refers to a compound having one or more phenolic hydroxyl groups.

In one aspect of the present invention, the phenolic compound is represented by the following Formula (1).

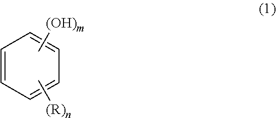

In Formula (1), R is selected from a substituted or unsubstituted alkyl group having 1 to 3 carbon atoms, a substituted or unsubstituted alkenyl group having 1 to 3 carbon atoms, a halogen atom, a carboxyl group, an acetyl group, and an alkoxy group having an alkyl chain having 1 to 3 carbon atoms.

A substituent of the alkyl group or the alkenyl group is selected from a hydroxyl group, a phenyl group, and an ether group.

The halogen atom is preferably fluorine or chlorine.
m is an integer of 1 to 3.
n is 0 to 3, preferably 0 to 2, and more preferably 0 or 1.

Non-limiting examples of the compound (A) represented by Formula (1) are shown below.

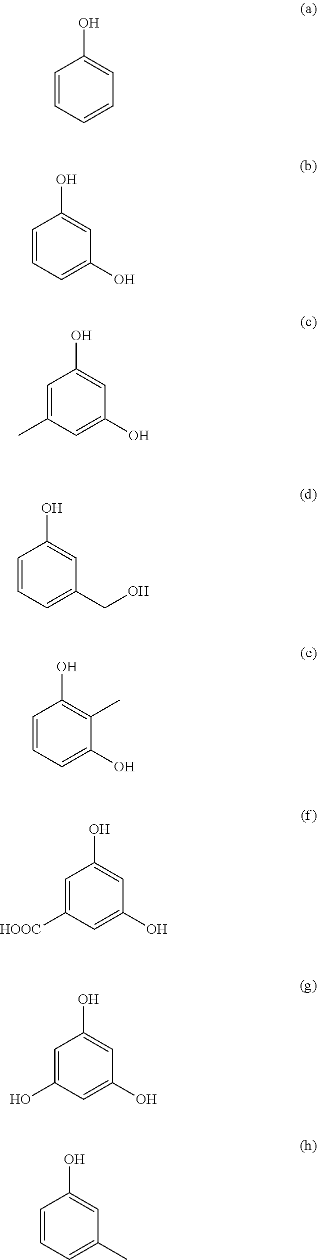

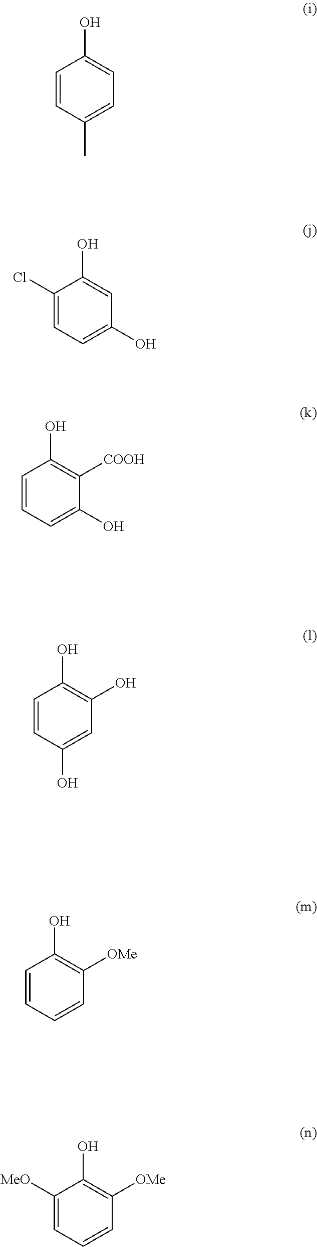

Among the compounds, the compounds (a) to (g), (k), and (1) can be preferably used as the compound (A).

As the urea-based compound, in addition to urea (NH₂—CO—NH₂), a part of hydrogen atoms (one hydrogen atom of each of both amino groups or one hydrogen atom of one amino group) of the amino group of urea may be substituted with another atom (for example, a substituted or unsubstituted alkyl group having 1 to 3 carbon atoms).

As the melamine-based compound, in addition to melamine, a compound in which one hydrogen atom of one or two amino groups of three amino groups of melamine is substituted with another atom (for example, a substituted or unsubstituted alkyl group having 1 to 3 carbon atoms) may be used.

The aldehyde-based compound is represented by R—CHO. R is selected from the group consisting of hydrogen, a substituted or unsubstituted alkyl group having 1 to 14 carbon atoms, and a substituted or unsubstituted aryl group. The alkyl group may be a cyclic alkyl group (for example, a cyclohexyl group or the like).

Examples of a substituent of the alkyl group include halogen (for example, fluorine or chlorine) and a phenyl group.

Examples of a substituent of the aryl group include an alkyl group having 1 to 3 carbon atoms and halogen (for example, fluorine or chlorine).

The aldehyde-based compound is preferably formaldehyde, acetaldehyde, benzaldehyde, phenylacetaldehyde, or the like.

### (2) Solution Containing Aldehyde-Based Compound and Compound (A)

A solvent of the solution containing the aldehyde-based compound and the compound (A) is preferably water. In the method for preparing a thermosetting resin of the present invention, the base generated near the surface of the electrode is preferably a hydroxyl group ion, and water is preferably used because hydroxyl group ions can be efficiently generated from water.

As the solvent of the solution containing the aldehyde-based compound and the compound (A), an organic solvent capable of generating a base by applying a positive potential to the electrode can also be used. Examples of such an organic solvent include methanol and ethanol. In a case where water and an organic solvent are used in combination, a ratio of water to an organic solvent such as methanol or ethanol is preferably 3:1 to 1:3. By using such an organic solvent, a melamine-based compound can be used as the compound (A). In addition, by using such an organic solvent, it is possible to thicken an ultra-thin film containing a thermosetting resin.

In addition, it is also possible to prepare a solution in which the compound (A) is dissolved in a mixed solvent of water and methanol or ethanol, and use a mixture of the solution and an aqueous solution of an aldehyde-based compound.

The solution containing the aldehyde-based compound and the compound (A) preferably does not contain a supporting electrolyte. Electrolytic polymerization has been known as a method for forming a conductive thin film of polypyrrole, polyaniline, or the like. The electrolytic polymerization is a reaction in which radicals or ions generated near an electrode by electrolysis of a solution containing a supporting electrolyte and a monomer act as polymerization active species to initiate polymerization. In the electrolytic polymerization, since an electrolyte (typically sodium chloride or the like) is used, a base layer derived from a hydroxyl group is not formed on a surface of the electrode, and a layer of a cation (typically a sodium ion) is formed on a layer of an anion (typically a chloride ion or the like), such that a so-called electric double layer is formed. Therefore, the addition condensation of the aldehyde-based compound by the base catalyst does not proceed.

Therefore, in the present invention, a polymer thin film containing an electrolyte-free thermosetting resin can be obtained by generating a base directly from the solvent near the surface of the electrode without using a supporting electrolyte.

A concentration of the aldehyde-based compound in the solution containing the aldehyde-based compound and the compound (A) is usually 0.1 to 2 mol/L and preferably 0.5 to 1 mol/L.

A concentration of the compound (A) in the solution containing the aldehyde-based compound and the compound (A) is usually 0.1 to 2 mol/L and preferably 0.5 to 1 mol/L.

A concentration ratio of the aldehyde-based compound to the compound (A) is preferably 0.5 to 2.

### (3) Electrochemical Cell

The electrochemical cell used in the method for preparing a thermosetting resin of the present invention includes a working electrode and a counter electrode.

As the working electrode, a silicon wafer (for example, P-type (100), 0.005 to 0.01 Ωm), gold, stainless steel, copper, or the like can be used.

As the counter electrode, a platinum wire, gold, stainless steel, copper, a silicon wafer, or the like can be used.

The electrochemical cell usually also includes a reference electrode, and as the reference electrode, an Ag/AgCl electrode, Ag/Ag⁺, Ag, or the like can be used.

In the electrochemical cell, the working electrode and the counter electrode are disposed to face each other, and the solution containing the aldehyde-based compound and the compound (A) is disposed between both the electrodes. The reference electrode is disposed in the solution containing the aldehyde-based compound and the compound (A).

A material of the electrochemical cell is Teflon, a glass plate, stainless steel, or the like.

The electrochemical cell is required to have a structure in which the working electrode, the counter electrode, and the reference electrode are not energized. The electrochemical cell may be sealed or open.

In the method for preparing a thermosetting resin of the present invention, a positive potential is applied to the working electrode. The potential to be applied is usually +0.5 to 5 V (vs the reference electrode) and preferably +3 to 5 V (vs the reference electrode). When a potential is lower than the above voltage, an ultra-thin film is not formed, and when a potential is higher than the above voltage, a side reaction such as electrolytic polymerization of phenol proceeds.

A time for applying the potential is appropriately determined depending on the concentrations of the aldehyde-based compound and the compound (A), the amount of the solution containing the aldehyde-based compound and the compound (A), and the like is usually 10 to 300 seconds. In addition, in a case where water and an organic solvent such as methanol or ethanol are used in combination as the solvent of the solution containing the aldehyde-based compound and the compound (A), it is preferable to apply a voltage for a longer time (for example, about 1 hour).

The polymerization reaction in the electrochemical cell is performed usually at 10 to 50° C. and preferably at about 30° C.

### (4) Thermosetting Resin

The type of the thermosetting resin obtained by the method for preparing a thermosetting resin of the present invention varies depending on the type of the compound (A) to be used.

In a case where a phenolic compound is used as the compound (A), a phenolic resin is obtained as a thermosetting resin.

In a case where a urea-based compound is used as the compound (A), a urea-based resin is obtained as a thermosetting resin.

In a case where a melamine-based compound is used as the compound (A), a melamine-based resin is obtained as a thermosetting resin.

In a general method for preparing a phenolic resin or the like, an intermediate of a polymer called novolac or resol is three-dimensionally crosslinked (cured) by using a heating or curing agent. On the other hand, in the method for preparing a thermosetting resin of the present invention, for example, in the preparation of a phenolic resin, a phenolic resin is obtained directly from a raw material phenolic compound and aldehyde-based compound without undergoing an intermediate such as resol or novolac. Since the resin obtained here already has a three-dimensionally crosslinked structure, it is insoluble in a solvent and cannot be dissolved by heat.

### (5) Other Steps

The method for preparing a thermosetting resin of the present invention can include recovering the thermosetting resin generated on the working electrode. Since the thermosetting resin is usually produced as a thin film, the thin film can be peeled off and recovered by immersing the working electrode in pure water or the like.

### 2. Method for Producing Ultra-Thin Film Containing Thermosetting Resin

Another embodiment of the present invention is a method for producing an ultra-thin film containing a thermosetting resin (hereinafter, also referred to as a “production method of an ultra-thin film of the present invention”), the method comprising: introducing a solution containing an aldehyde-based compound and a compound (A) capable of undergoing addition condensation with an aldehyde-based compound into an electrochemical cell including a working electrode and a counter electrode and applying a positive potential to the working electrode to form a thin film on the working electrode.

Details of the compound (A), the aldehyde-based compound, the solution containing the aldehyde-based compound and the compound (A), the electrochemical cell, the application of the positive potential, the thermosetting resin, and the like in the method for producing an ultra-thin film of the present invention are the same as those described in detail above for the method for preparing a thermosetting resin of the present invention.

In one preferred aspect of the method for producing an ultra-thin film of the present invention, the compound (A) is at least one compound selected from the group consisting of a phenolic compound, a urea-based compound, and a melamine-based compound.

In one preferred aspect of the method for producing an ultra-thin film of the present invention, the compound (A) is a phenolic compound.

In one preferred aspect of the method for producing an ultra-thin film of the present invention, the positive potential is applied to the working electrode to generate a base near a surface of the working electrode.

In one preferred aspect of the method for producing an ultra-thin film of the present invention, the solution containing the aldehyde-based compound and the compound (A) does not contain a supporting electrolyte.

As described above for the method for preparing a thermosetting resin of the present invention, in the method for producing an ultra-thin film of the present invention, an electrolyte-free ultra-thin film can be obtained by generating a base directly from a solvent near the surface of the electrode without using a supporting electrolyte.

In the method for producing an ultra-thin film of the present invention, for example, in production of an ultra-thin film containing a phenolic resin, an ultra-thin film of a phenolic resin is obtained directly from a raw material phenolic compound and aldehyde-based compound without undergoing an intermediate such as resol or novolac. Since the ultra-thin film already has a three-dimensionally crosslinked structure, it is insoluble in a solvent and cannot be dissolved by heat.

In the method for producing an ultra-thin film of the present invention, a positive potential is applied to a working electrode to generate a base only near a surface of the electrode, such that a polymerization reaction between a compound (A) and an aldehyde-based compound proceeds near the surface. Therefore, it is possible to obtain a nanometer-sized ultra-thin film of a thermosetting resin which could not be obtained by conventional techniques.

The method for producing an ultra-thin film of the present invention can include recovering the ultra-thin film formed on the working electrode. The ultra-thin film can be peeled off and recovered by immersing the working electrode in pure water or the like.

One aspect of the present invention is an ultra-thin film obtained by the method for producing an ultra-thin film of the present invention.

The ultra-thin film obtained by the method for producing an ultra-thin film of the present invention has a nanosized thickness. The thickness of the ultra-thin film is preferably 10 to 100 nm and more preferably 10 to 60 nm.

### 3. Ultra-Thin Film Containing Thermosetting Resin

Still another embodiment of the present invention is an ultra-thin film containing a thermosetting resin (hereinafter, also referred to as an “ultra-thin film of the present invention”), in which the ultra-thin film is obtained by performing a polymerization reaction between an aldehyde-based compound and a compound (A) capable of undergoing addition condensation with an aldehyde-based compound.

In one preferred aspect of the present invention, an ultra-thin film 1 of the present invention is obtained by applying a positive potential to a working electrode in an electrochemical cell including the working electrode and a counter electrode to perform the polymerization reaction between the aldehyde-based compound and the compound (A) capable of undergoing addition condensation with an aldehyde-based compound on the working electrode (preferably, on the surface of the working electrode).

Details of the compound (A), the aldehyde-based compound, the electrochemical cell, the application of the positive potential, the thermosetting resin, and the like in the ultra-thin film of the present invention are the same as those described in detail above for the method for preparing a thermosetting resin of the present invention.

In one preferred aspect of the ultra-thin film of the present invention, the compound (A) is at least one compound selected from the group consisting of a phenolic compound, a urea compound, and a melamine compound.

In one preferred aspect of the ultra-thin film of the present invention, the compound (A) is an ultra-thin film of a phenolic compound (hereinafter, also referred to as a “phenolic resin ultra-thin film of the present invention”).

The ultra-thin film of the present invention has a nanosized thickness. The thickness of the ultra-thin film of the present invention is preferably 10 to 800 nm and more preferably 10 to 60 nm. As described above, by using water and an organic solvent such as ethanol as the solvent of the solution containing the aldehyde-based compound and the compound (A), it is possible to thicken the ultra-thin film containing the thermosetting resin, and to obtain an ultra-thin film having a thickness of more than 60 nm and about 800 nm.

The thickness of the ultra-thin film can be usually measured using an atomic force microscope (AFM).

The ultra-thin film of the present invention has an extremely smooth surface. A surface roughness of the ultra-thin film of the present invention is preferably 1 to 10 nm and more preferably 1 to 5 nm. The surface roughness of the ultra-thin film can be usually measured using an AFM.

Since the ultra-thin film of the present invention has a three-dimensionally crosslinked structure, it is insoluble in a solvent and cannot be dissolved by heat.

A Young's modulus of the ultra-thin film of the present invention is preferably 8 to 20 GPa.

Still another embodiment of the present invention is a thermosetting resin obtained by performing a polymerization reaction between an aldehyde-based compound and a compound (A) capable of undergoing addition condensation with an aldehyde-based compound (hereinafter, also referred to as a “thermosetting resin of the present invention”), in which a density of the thermosetting resin is 0.2 to 0.7 g/cm³, and a Young's modulus of the thermosetting resin is 8 to 20 GPa.

Although there is no ordinary synthetic resin having a Young's modulus exceeding 10 GPa, the thermosetting resin of the present invention has a property of having significantly high strength although it has a low density.

In addition, the thermosetting resin of the present invention has a net-like (mesh-like) structure having nanometer-sized pores, a so-called loofah-like structure. When water is absorbed, the Young's modulus is decreased by about one digit.

The thermosetting resin of the present invention can be prepared by the method for preparing a thermosetting resin of the present invention described above.

Details of the compound (A), the aldehyde-based compound, and the like in the thermosetting resin of the present invention are the same as those described above for the method for preparing a thermosetting resin of the present invention.

In one preferred aspect of the thermosetting resin of the present invention, the compound (A) is at least one compound selected from the group consisting of a phenolic compound, a urea compound, and a melamine compound.

In one preferred aspect of the thermosetting resin of the present invention, the compound (A) is a phenolic compound (hereinafter, also referred to as a “phenolic resin of the present invention”).

The phenolic resin of the present invention has a property that the number of formaldehyde-derived moieties is smaller than that of a general phenolic resin. In the general phenolic resin, the number of aldehyde-derived moieties is about 2 to 3 with respect to 10 benzenes, but the phenolic resin of the present invention has about 0.5 to 1 aldehyde-derived moiety with respect to 10 benzenes.

One aspect of the present invention is an ultra-thin film comprising the thermosetting resin of the present invention.

The ultra-thin film has a nanosized thickness. The thickness of the ultra-thin film is preferably 10 to 800 nm and more preferably 10 to 60 nm. As described above, by using water and an organic solvent such as ethanol as the solvent of the solution containing the aldehyde-based compound and the compound (A), it is possible to thicken the ultra-thin film containing the thermosetting resin, and to obtain an ultra-thin film having a thickness of more than 60 nm and about 800 nm.

The thickness of the ultra-thin film can be usually measured using an atomic force microscope (AFM).

The ultra-thin film of the present invention and the ultra-thin film comprising the thermosetting resin of the present invention described above (hereinafter, both are collectively referred to as an “ultra-thin film or the like of the present invention”) have a property that a removal rate of a dye is high at an appropriate pH in spite of a high water permeation rate. In one aspect of the ultra-thin film of the present invention, at a pH of about 10, the water permeation rate is 45 to 60 Lm⁻²h⁻¹bar⁻¹, and the removal rate of the dye is 90 to 100%.

Here, a water flow rate (permeation rate) (J, Lm⁻²h⁻¹bar⁻¹) is calculated by the following equation using a volume (V, L) of a permeated solution, an operating area (A, m²) of a film, a permeation time (t, h), and a pressure (p, bar).

$$J = V / ( A \times t \times p ) \qquad [ Math . 1 ]$$

In addition, a rejection rate (R, %) of the dye is calculated by the following equation using a dye concentration (C_{f}) before filtration and a dye concentration (Cₚ) after filtration.

$$R = ( 1 - {C}_{p} / {C}_{f} ) \times 100 \qquad [ Math . 2 ]$$

### 4. Composite Thin Film

Still another embodiment of the present invention is a composite thin film comprising any one of the ultra-thin films of the present invention, and one or more films selected from the group consisting of a nitrocellulose film, a nylon film, and a Teflon film (hereinafter, also referred to as a “composite thin film of the present invention”).

One aspect of the present invention is a composite thin film comprising the phenolic resin ultra-thin film of the present invention, and one or more films selected from the group consisting of a nitrocellulose film, a nylon film, and a Teflon film (hereinafter, also referred to as a “composite thin film A of the present invention”).

### 5. Applications of Ultra-Thin Film of Present Invention

The ultra-thin film of the present invention can be used as a filtration membrane because it has high water permeability and separation ability.

That is, one aspect of the present invention is a filtration membrane comprising any one of the ultra-thin films of the present invention or the composite thin film of the present invention (hereinafter, also referred to as a “filtration membrane of the present invention”).

One aspect of the present invention is a filtration membrane comprising the phenolic resin ultra-thin film of the present invention or the composite thin film A of the present invention.

The filtration membrane obtained using the phenolic resin ultra-thin film of the present invention has particularly high water permeability and separation ability.

Examples of a substance that can be separated by the filtration membrane of the present invention include various dyes, for example, cationic dyes (methylene blue hydrate, crystal violet, and the like) and anionic dyes (Brilliant Blue G, methyl orange, acid orange, and the like).

Since the filtration membrane obtained using the phenolic resin ultra-thin film of the present invention has a hydroxyl group on the surface, selective separation can be performed depending on a difference in charge of the substance to be separated.

For example, methyl orange (molecular weight: 327) which is an anionic dye can have a significantly high water permeation constant although a removal rate is low, and methylene blue hydrate (molecular weight: 320) which is a cationic dye can have a significantly high removal rate although a water permeation constant is low.

In addition, the filtration membrane obtained using the phenolic resin ultra-thin film of the present invention can chemically modified to adjust the separation ability.

After forming the ultra-thin film, for example, when the ultra-thin film is treated with a base such as a sodium hydroxide solution and then is subjected to separation of an anionic dye such as methyl orange, the removal rate can be significantly increased although the water permeation constant is reduced. Thereafter, for example, when the filtration membrane is treated with an acid such as hydrochloric acid and then is subjected to separation of an anionic dye such as methyl orange G, the water permeation constant can be significantly increased although the removal rate is reduced.

While not intending to be bound by theory, it is considered that when the filtration membrane is treated with a base, the hydroxyl group (—OH) on the surface becomes an anion (—O—), and a removal rate of the anionic dye can be remarkably increased due to charge repulsion, while a subsequent acid treatment restores the surface to a hydroxyl group, and the anionic dye can be removed by a size exclusion effect.

In addition, the phenolic resin ultra-thin film of the present invention can be applied to a product for controlling bacteria, viruses, or the like (for example, a mask, a food packaging film, a skin care product, or the like) because it has a sterilization effect.

One aspect of the present invention is a mask comprising the phenolic resin ultra-thin film of the present invention or the composite thin film A of the present invention.

In addition, the ultra-thin film or the like of the present invention or the composite thin film A of the present invention can be used for various applications, for example, for a thin-film conductive film, a semiconductor clean room, a pharmaceutical laboratory, a medical chemical filter, and the like.

In addition, since a phenolic resin generally has a property of having a high residual carbon rate (a carbon residual content when combusted in an inert atmosphere), it can be used as a (hard) carbon raw material. Therefore, the phenolic resin is also used in the fields of a negative electrode material carbon raw material of a lithium ion battery, a pharmaceutical activated carbon raw material, an activated carbon electrode raw material of a capacitor, and a carbon raw material for producing silicon carbide or boron carbide. However, the ultra-thin film of the present invention or the composite thin film A of the present invention can be used as a negative electrode material of a film-shaped lithium ion battery, a pharmaceutical activated carbon, or an activated carbon electrode of a capacitor.

In addition, a carbonized film can be obtained by heating the ultra-thin film or the like of the present invention at a temperature of about 800° C. for several hours (for example, about 1 hour) under a nitrogen stream (for example, about 100 mL/h).

That is, one aspect of the present invention is a carbonized film obtained by carbonizing the ultra-thin film or the like of the present invention (hereinafter, also referred to as a “carbonized film of the present invention”).

The carbonized film of the present invention has a significantly small thickness, for example, 1 to 5 nm. Since the carbonized film of the present invention is considered to have high mechanical strength, the carbonized film can be used by being laminated on the outermost surface in order to change properties of a surface of an electrode or the like.

### EXAMPLES

Hereinafter, the present invention will be described in more detail with reference to Examples, but the present invention is not limited to these Examples.

### Synthesis Example 1

### Synthesis of Ultra-Thin Film

A formaldehyde aqueous solution (37 wt %, 1.6 g, 20 mmol) was added to an aqueous solution (20 mL) of resorcinol (1.1 g, 10 mmol), and stirring was performed for 10 minutes. The solution was introduced into an electrochemical cell using a silicon wafer (P type (100), 0.005 to 0.01 Ωm) as a working electrode, a platinum wire as a counter electrode, and an Ag/AgCl electrode as a reference electrode, and a voltage of +5.0 V (vs. Ag/AgCl) was applied at 25° C. for 1 minute. When the working electrode after voltage application was immersed in pure water, an ultra-thin film having a thickness of 58 nm and a surface roughness of 2.2 nm was peeled off.

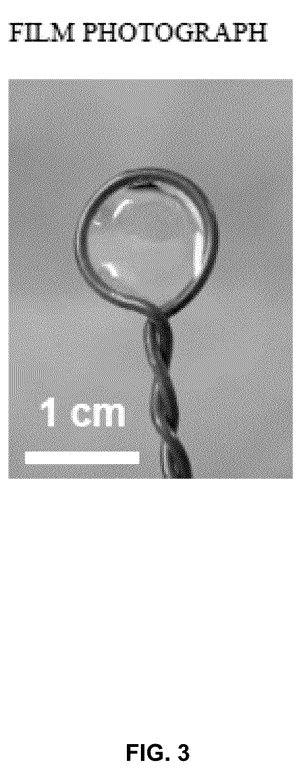

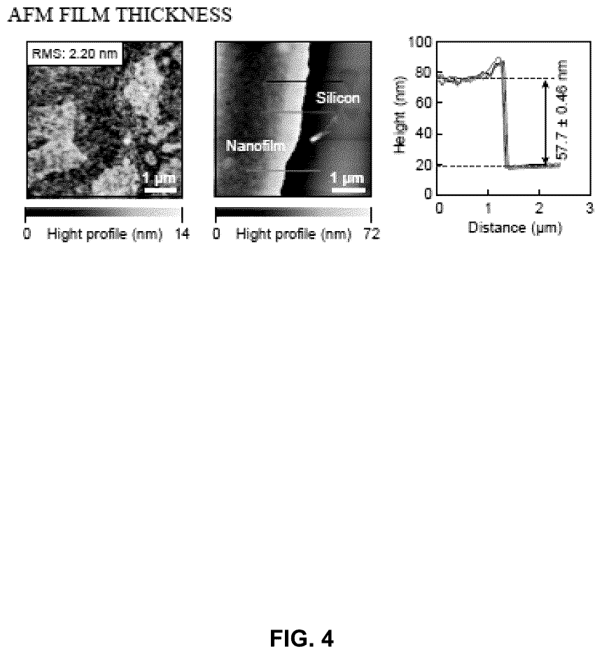

The photograph of the obtained ultra-thin film is illustrated in FIG. 3, and the results of measuring the film thickness with an AFM are illustrated in FIG. 4. A surface roughness was obtained by analyzing a thickness distribution of a film portion of an AFM image.

Note that the ultra-thin film cast on the silicon wafer was measured using NanoNavi S-image of SII NanoTechnology Inc. as the AFM and SI-DF40P2 cantilever.

### Results of Measuring Infrared Absorption Spectrum (JASCO FT/IR-6100)

IR (film): 3226 (bs), 2917 (s), 2858 (s), 1600 (s), 1497 (m), 1458 (m), 1480 (m), 1373 (w), 1291 (w), 1217 (w), 1146 (s), 1097 (m), 960 (s), 835 (s)

### Synthesis Example 2

An ultra-thin film was synthesized under the same conditions as those of Synthesis Example 1, except that phenol (0.9 g, 10 mmol) was used instead of resorcinol as the phenolic compound. When the working electrode after voltage application was immersed in pure water, an ultra-thin film having a thickness of 53 nm and a surface roughness of 3.3 nm was peeled off.

### Synthesis Example 3

An ultra-thin film was synthesized under the same conditions as those of Synthesis Example 1, except that 5-methylresorcinol (1.2 g, 10 mmol) was used instead of resorcinol as the phenolic compound. When the working electrode after voltage application was immersed in pure water, an ultra-thin film having a thickness of 40 nm and a surface roughness of 3.4 nm was peeled off.

### Synthesis Example 4

An ultra-thin film was synthesized under the same conditions as those of Synthesis Example 1, except that 3-hydroxybenzyl alcohol (1.2 g, 10 mmol) was used instead of resorcinol as the phenolic compound. When the working electrode after voltage application was immersed in pure water, an ultra-thin film having a thickness of 68 nm and a surface roughness of 8.8 nm was peeled off.

### Synthesis Example 5

An ultra-thin film was synthesized under the same conditions as those of Synthesis Example 1, except that 2-methylresorcinol (1.2 g, 10 mmol) was used instead of resorcinol as the phenolic compound. When the working electrode after voltage application was immersed in pure water, an ultra-thin film having a thickness of 37 nm and a surface roughness of 2.5 nm was peeled off.

### Synthesis Example 6

An ultra-thin film was synthesized under the same conditions as those of Synthesis Example 1, except that 3,5-dihydroxybenzoic acid (1.5 g, 10 mmol) was used instead of resorcinol as the phenolic compound. When the working electrode after voltage application was immersed in pure water, an ultra-thin film having a thickness of 13 nm and a surface roughness of 1.6 nm was peeled off.

### Example 1

### Permeation Experiment

The ultra-thin film floating in water obtained in Synthesis Example 1 was placed on a nitrocellulose film (MF-Millipore membrane, diameter of 13 mm, thickness of 100 μm, pore diameter of 100 nm, porosity of 74%) to form a composite thin film. The composite thin film was set in a stainless steel membrane holder, and an aqueous solution (10 ppm) in which a dye was dissolved was passed through the composite thin film at room temperature and a pressure of 2 bar. A flow rate (J, Lm⁻²h⁻¹bar⁻¹) was calculated by the following equation using a volume (V, L) of a permeated solution, an operating area (A, m²) of a film, a permeation time (t, h), and a pressure (p, bar).

$$J = V / ( A \times t \times p ) \qquad [ Math . 3 ]$$

In addition, a rejection rate (R, %) of the dye was calculated by the following equation using a dye concentration (C_{f}) before filtration and a dye concentration (Cₚ) after filtration.

$$R = ( 1 - {C}_{p} / {C}_{f} ) \times 100 \qquad [ Math . 4 ]$$

The concentration was calculated using an infrared-visible absorption spectrum.

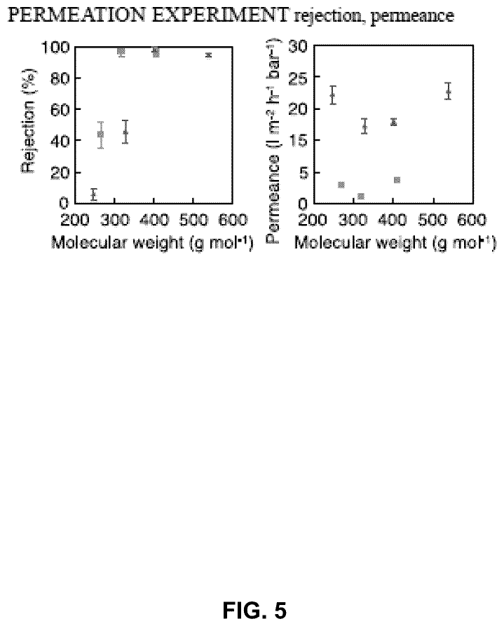

The results of the permeation experiment are illustrated in FIG. 5. Here, a dropping experiment of various dyes having different molecular weights was performed, and the rejection rate (left drawing) and the flux of the solution are illustrated (right drawing). In the drawing, red (▴) indicates a plot relating to an anionic dye, and green (▪) indicates a plot relating to a cationic dye. When the rejection rates are compared, it is found that the anionic dye has a property of easily permeating a film having a larger molecular weight than the cationic dye. In addition, when the fluxes are compared, it is found that the flux is high in the case of the anionic dye.

In addition, the films synthesized in Synthesis Examples 2 to 6 have hydroxyl groups having different acidities, and a large change can be expected in the performance of film separation and the chemical structure that can be modified. For example, 3,5-dihydroxybenzoic acid has a carboxyl group having high acidity. Therefore, it is expected that the ability to filter cations is more enhanced (smaller molecules can also be removed), and modification to metal ions becomes easier.

### Example 2

### Antimicrobial and Antiviral Test of Ultra-Thin Film

### (1) Ultra-Thin Film for Physiological Activity Tests

In each antimicrobial, antimicrobial and antiviral, and anti-lentivirus assay, a film prepared by applying an external potential (5.0 V vs Ag/AgCl) to resorcinol (0.5 M) and formaldehyde (1.0 M) dissolved in deionized water at 30° C. for 1 minute was used. After the reaction, the solution was pipetted out of the electrochemical cell and washed four times with deionized water to remove a residual starting material. Subsequently, the electrochemical cell was disassembled, and the electrode substrate was immersed in deionized water, thereby obtaining a free-standing film having a thickness of up to 60 nm.

The film was scooped up on a glass slide (MATSUNAMI, 18 mm×18 mm) and dried under the atmosphere. As a control sample, an untreated glass plate (MATSUNAMI, 18 mm×18 mm) was used. All the physiological activity tests were performed at least three times to ensure reproducibility and calculate a standard deviation.

### (2) Antimicrobial Test

E. coli JW0603 strain (BW25113, rna: KmR) was cultured in Luria-Bertani (LB) medium at 37° C. overnight.

On the next day, 3 μl of a culture solution adjusted to OD₆₀₀=1 was pipetted onto each of an ultra-thin film and a control sample, covered with a glass plate, and then cultured at 37° C. for 18 hours. After the culturing, cells interposed between each of the ultra-thin film and the control sample and the glass plate were transferred to 5 ml of an LB medium together with the glass plate and eluted (E. coli test suspension). 700 μl of each E. coli test suspension was seeded on an LB plate containing kanamycin and cultured at 37° C. for 18 hours. A colony forming unit (CFU) value (CFU/ml) of each E. coli test suspension was calculated from the number of colonies. A bacterial load difference (BLD) was calculated based on Formula (S5) as a reduction rate of CFU after the culturing at 37° C. for 18 hours.

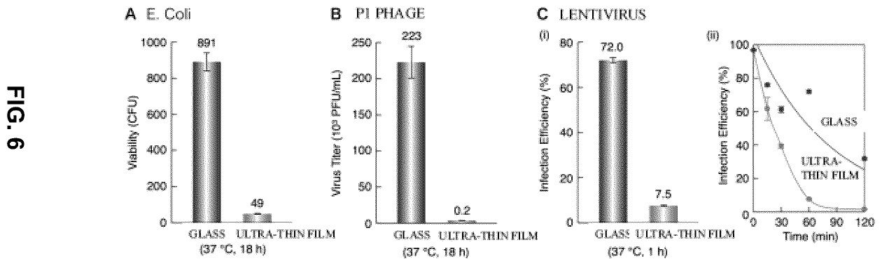

The results are illustrated in A of FIG. 6. This drawing shows that the growth of E. coli is inhibited on the ultra-thin film.

### (3) Antimicrobial and Antiviral Test

A P1 phage solution was prepared by the method reported by Lynn C. Thomason et al. (Thomason, L. C., Costantino, N. & Court, D. L. E. coli Genome Manipulation by P1 Transduction. Current Protocols in Molecular Biology 79, 1.17.1-1.17.8 (2007)). Similar to the antimicrobial assay, 3 μl of a P1 phage solution was pipetted onto each of an ultra-thin film and a control sample, covered with a glass plate, and incubated at 37° C. for 18 hours. In the antimicrobial and antiviral test, E. coli JW0603 strain (BW25113, rna: KmR) was used as an indicator bacterium. The JW0603 strain was cultured in an LB medium overnight to prepare an indicator bacterial culture solution. 300 μl of a P1 phage test suspension was mixed with 300 μl of an indicator bacterial culture solution containing 5 mM CaCl₂), and the mixture was incubated at 37° C. for 15 minutes (P1 transformation mixed solution). Subsequently, 3 ml of LB-top agar (0.7% Agarose, 5 mM CaCl₂)) was added to the P1 introduction mixed solution, and the mixture was spread on an LB plate and cultured at 37° C. for 18 hours. A plaque forming unit (PFU) value (PFU/ml) of the P1 phage test suspension was calculated from the number of plaques present in the LB-top agar.

The results are illustrated in B of FIG. 6. This drawing shows that the growth of PI phage is inhibited on the ultra-thin film.

### (4) Antiviral Test

A lentiviral suspension for expressing green fluorescent protein (GFP) was prepared from a medium when HEK293T cells transfected with pLenti-CMV-GFP-Puro, pMD2. G, pRS-REV, and pMDLg/pRRE vectors (Addgene) were cultured according to previous reports (Tiscornia, G., Singer, O. & Verma, I. M. Production and purification of lentiviral vectors. Nature protocols 1, 241 (2006), Campeau, E. et al. A Versatile Viral System for Expression and Depletion of Proteins in Mammalian Cells. PLOS ONE 4, e6529 (2009)). 12 μl of a lentiviral suspension was pipetted by 6 μl onto ultra-thin films and control samples, covered with a glass plate, and then incubated at 37° C. for 15, 30, 60, 120, 240 minutes. After the incubation at each time, the lentiviral solution was eluted with 1 ml of DMEM (10% FBS, 1% penicillin-streptomycin) (lentiviral test suspension). The day before transduction, HEK293T cells were seeded by 1×10⁵ in each well of a 24 well cluster plate, and immediately before transduction, the medium of HEK293T cells was replaced with 800 μl of new DMEM (10% FBS, 1% penicillin-streptomycin). Subsequently, 200 μl of each lentiviral test suspension was added to a medium containing polybrene at a final concentration of 4 mg/ml. For preparation of the lentiviral test suspension after 0 minutes, 12 μl of lentivirus was diluted directly in 1 ml of DMEM (10% FBS, 1% penicillin-streptomycin). After culturing at 37° C. and 5% CO₂ for 3 days, infected cells expressing GFP were observed by flow cytometry (Guava easyCyte, manufactured by Merck Millipore). A value of infection efficiency was calculated from the number of cells expressing GFP.

The results are illustrated in C of FIG. 6. This drawing shows that the growth of PI phage is inhibited on the ultra-thin film.

### Example 3

### Evaluation of Properties of Ultra-Thin Film

### (1) XPS Measurement

XPS was measured using the ultra-thin film obtained in Synthesis Example 1.

XPS measurement was performed with ULVAC PHI 5000 Versaprobe using Al Kα (12 kV, 25 mA) as an X-ray source.

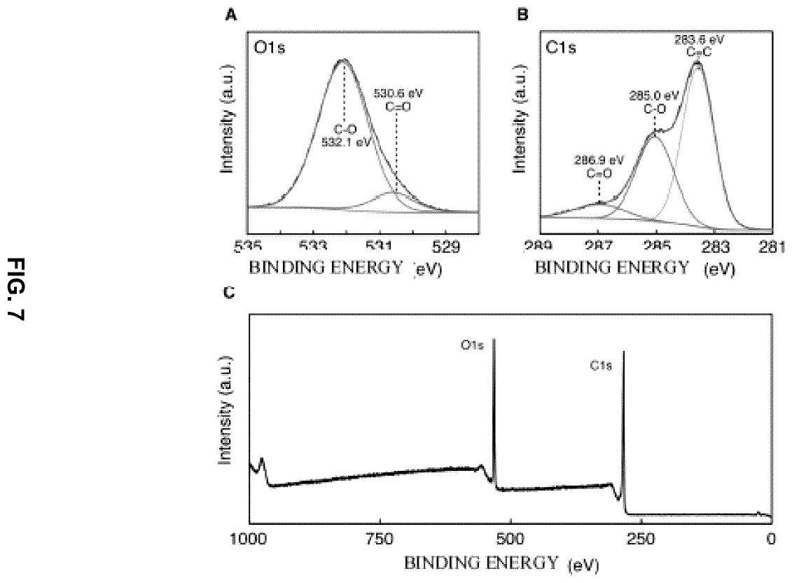

The obtained spectra are illustrated in FIG. 7.

From the O1s spectrum (A), a peak (532.1 eV) considered to be derived from —OH of resorcinol was observed, and at the same time, a peak of oxidized species was also observed (530.6 eV). From the C1s spectrum (B), a peak (286.9 eV) considered to be an oxidized species was observed, in addition to a peak (283.6 eV) of a carbon-carbon double bond considered to be derived from benzene and a peak (285.0 eV) considered to be derived from C—OH of resorcinol. Since no noticeable peaks other than carbon and oxygen were observed in the spectrum (C) of the wide-area scan, it is considered that contamination of other components is extremely small.

### (2) Measurement of Nanoindentation

In order to measure the strength of the ultra-thin film, nanoindentation was measured using the ultra-thin film obtained in Synthesis Example 1.

The nanoindentation measurement was performed with ELIONIX ENT-NEXUS at 30° C. using a low-load unit.

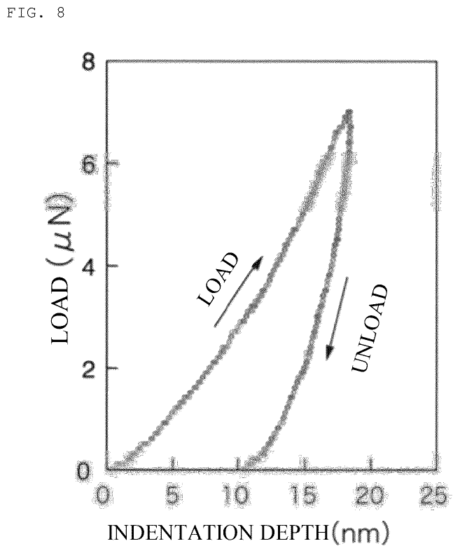

The obtained results are illustrated in FIG. 8. Here, in FIG. 8, the Young's modulus can be calculated from the inclination of the first tangent of the graph of unloading. The calculated Young's modulus was 11.2±0.6 GPa.

Since no ordinary synthetic resin has a Young's modulus exceeding 10 GPa, it can be said that the ultra-thin film of the present invention is a film having significantly high strength.

### (3) Measurement of ¹³CNMR

¹³C labeled formaldehyde was used to measure ¹³CNMR of the thin film synthesized according to Synthesis Example 1. The measurement was performed at 25° C. using JEOL JNM-ECZ700R.

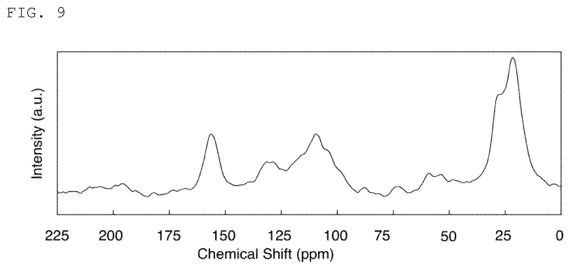

The obtained spectra are illustrated in FIG. 9. In addition, the chemical shift is as follows.

δ 208.0, 196.3, 156.1, 130.4, 116.1, 109.1, 103.6, 98.6, 87.9, 73.3, 54.7, 29.2, 21.5 ppm

From this result, it was found that the number of moieties derived from formaldehyde was approximately one with respect to 10 benzenes.

### (4) Measurement of Density

Using the ultra-thin film obtained in Synthesis Example 1, a density was measured using X-ray reflectance measurement.

The measurement was performed at 25° C. using RIGAKU SmartLab 9 kW.

As a result, the density was 0.499 g/cm³.

### (5) pH Responsiveness (Film Thickness)

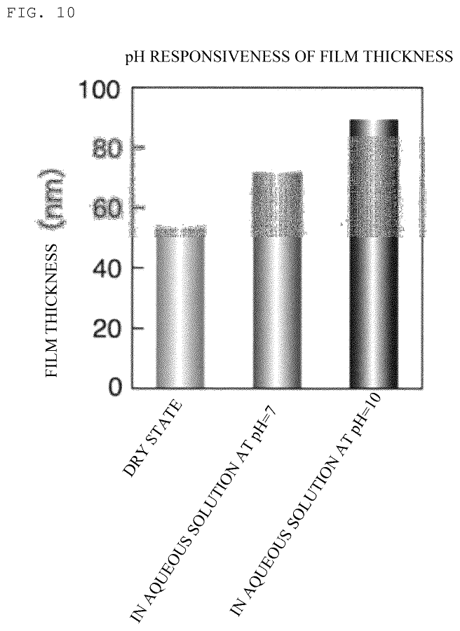

Using the ultra-thin film obtained in Synthesis Example 1, a change in thickness of the ultra-thin film depending on a pH was examined. The results thereof are illustrated in FIG. 10.

The film thickness under each condition was 53.2 nm in a dry state, 71.6 nm in an aqueous solution at pH=7, and 89.4 nm in an aqueous solution at pH=10. From this result, it can be understood that the ultra-thin film of the present invention swells by absorbing water, and a degree of swelling is increased as the pH is increased.

### (6) pH Responsiveness (Permeation Rate and Removal Rate)

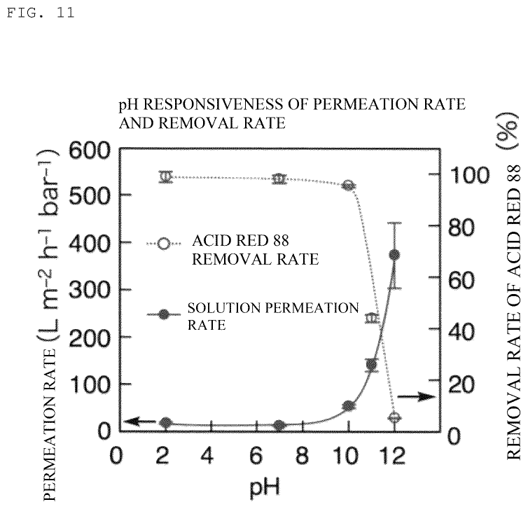

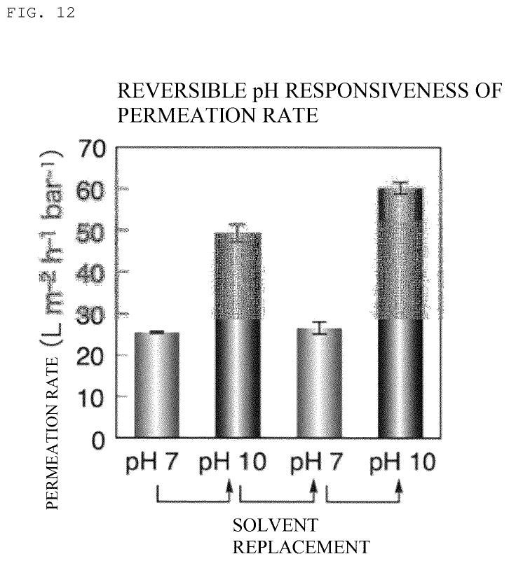

Using the ultra-thin film obtained in Synthesis Example 1, changes in permeation rate of the ultra-thin film and removal rate of the dye (Acid Red 88) depending on a pH were examined. Methods for measuring the permeation rate and the removal rate are as described in Example 1. In addition, reversibility of the permeation rate when the pH was changed from 7→10→7→10 was examined. The results are illustrated in FIGS. 11 and 12.

FIG. 11 illustrates that when the pH is increased, the permeation rate is increased from the pH of around 8, and the removal rate is decreased.

In addition, as illustrated in FIG. 12, when the pH is changed from 7 to 10, the permeation rate is increased by about 2 times, and when the pH is returned to 7, the permeation rate is decreased. This indicates that the change in permeation rate of the ultra-thin film by the pH is a reversible change. Therefore, the permeation rate of the ultra-thin film of the present invention can enable the ultra-thin film to be ON/OFF controlled by the pH.

### (7) pH Responsiveness (Young's Modulus)

Using the ultra-thin film obtained in Synthesis Example 1, a change in Young's modulus of the ultra-thin film depending on a pH was examined. The measurement was performed by an in-liquid AFM using Bruker MultiMode 8-HR.

The Young's modulus under each condition was 8.94±1.19 GPa in a dry state, 2.90±0.12 GPa in an aqueous solution at pH=7, and 0.50±0.082 GPa in an aqueous solution at pH=10.

As described above, the ultra-thin film of the present invention has a Young's modulus of about 10 GPa in a dry state, but has a property that the Young's modulus is decreased by about one digit when the ultra-thin film absorbs water.

As described above, since the ultra-thin film of the present invention has a density of 0.499 g/cm³ in a dry state, it is considered that the ultra-thin film has nanometer-sized pores. In addition, since the ultra-thin film of the present invention also has a property of swelling when absorbing water, it is presumed that the ultra-thin film has a loofah-like structure.

### Example 4

### Synthesis Example of Thick Film

A formaldehyde aqueous solution (37 wt %, 1.6 g, 20 mmol) was added to a water-methanol solution (20 mL, water:methanol=60:40) of resorcinol (1.1 g, 10 mmol), and stirring was performed for 10 minutes. The solution was introduced into an electrochemical cell using a silicon wafer (P type (100), 0.005 to 0.01 Ωm) as a working electrode, a platinum wire as a counter electrode, and an Ag/AgCl electrode as a reference electrode, and a voltage of +5.0 V (vs. Ag/AgCl) was applied at 30° C. for 1 hour. When the working electrode after voltage application was immersed in pure water, an ultra-thin film having a thickness of 655 nm and a surface roughness of 2.8 nm was peeled off.

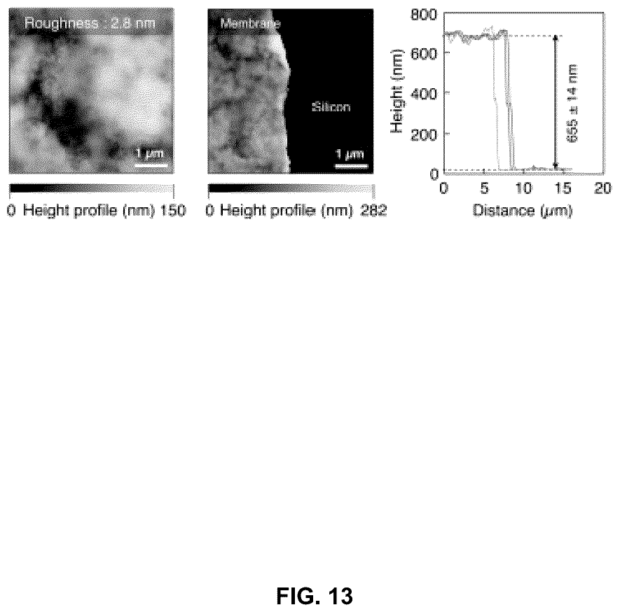

The results of measuring the thickness of the obtained ultra-thin film with an AFM are illustrated in FIG. 13. A surface roughness was obtained by analyzing a thickness distribution of a film portion of an AFM image.

Note that the ultra-thin film cast on the silicon wafer was measured using NanoNavi S-image of SII NanoTechnology Inc. as the AFM and SI-DF40P2 cantilever.

### Results of Measuring Infrared Absorption Spectrum (JASCO FT/IR-6100)

IR (film): 3223 (bs), 2918 (w), 2849 (w), 1603 (s), 1498 (m), 1458 (m), 1355 (w), 1282 (w), 1228 (w), 1100 (s), 1148 (m), 963 (s), 838 (s)

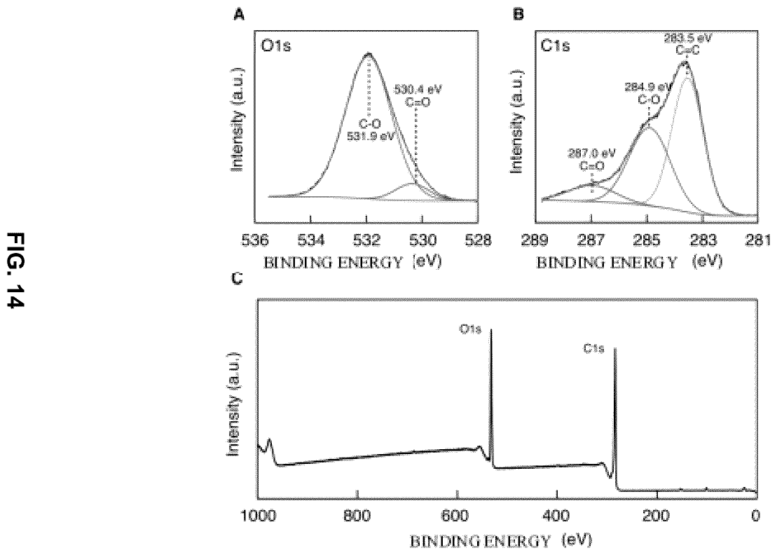

FIG. 14 illustrates results of measuring an XPS spectrum of the obtained ultra-thin film.

Density measurement using X-ray reflectance measurement of the obtained ultra-thin film was performed. As a result, the density was 0.394 g/cm³.

### Example 5

### Synthesis Example of Carbonized Film

An ultra-thin film (to 60 nm) cast on a silicon wafer was heated at 800° C. for 1 hour under a nitrogen stream (100 mL/h).

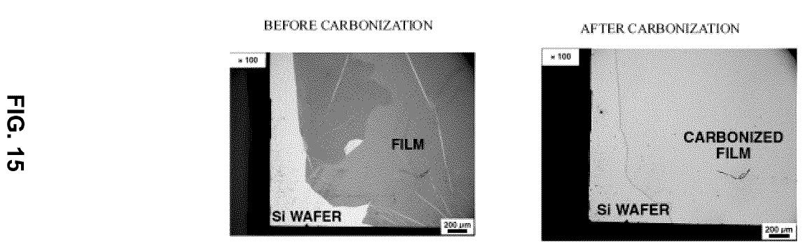

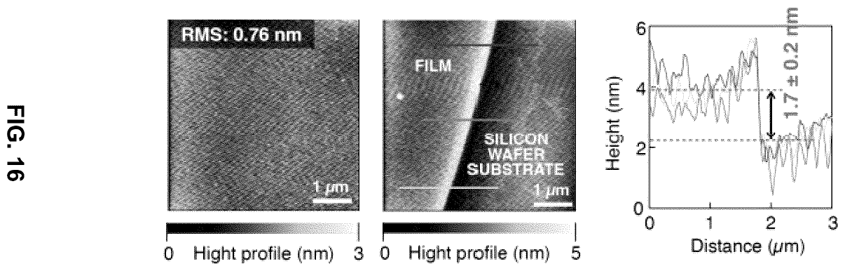

The optical microscopy image of the obtained carbonized film is illustrated in FIG. 15, and the results of measuring the film thickness with an AFM are illustrated in FIG. 16. A surface roughness was obtained by analyzing a thickness distribution of a film portion of an AFM image.

Note that the ultra-thin film cast on the silicon wafer was measured using NanoNavi S-image of SII NanoTechnology Inc. as the AFM and SI-DF40P2 cantilever.

As illustrated in FIG. 16, the thickness of the carbonized film was 1.7±0.2 nm, and it can be seen that the film thickness was significantly small due to carbonization.

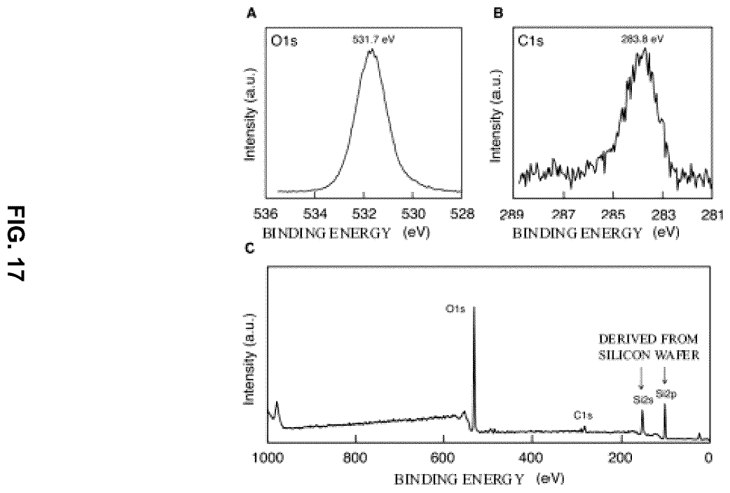

FIG. 17 illustrates results of measuring an XPS spectrum of the carbonized film obtained above.

1. A method for preparing a thermosetting resin, the method comprising:
providing a solution containing an aldehyde-based compound and a compound (A) capable of undergoing addition condensation with an aldehyde-based compound;
introducing the solution into an electrochemical cell including a working electrode and a counter electrode;
applying a positive potential to the working electrode; and
performing a polymerization reaction on the working electrode.

2. The method according to claim 1, wherein the compound (A) is at least one compound selected from the group consisting of a phenolic compound, a urea-based compound, and a melamine-based compound.

3. The method according to claim 1, wherein a base is generated near a surface of the working electrode by applying the positive potential to the working electrode.

4. The method according to claim 1, wherein the solution does not contain a supporting electrolyte.

5. A method for producing an ultra-thin film containing a thermosetting resin, the method comprising: introducing a solution containing an aldehyde-based compound and a compound (A) capable of undergoing addition condensation with an aldehyde-based compound into an electrochemical cell including a working electrode and a counter electrode and applying a positive potential to the working electrode to form a thin film on the working electrode.

6. An ultra-thin film comprising a thermosetting resin,
wherein the ultra-thin film is obtained by performing a polymerization reaction between an aldehyde-based compound and a compound (A) capable of undergoing addition condensation with an aldehyde-based compound.

7. The ultra-thin film according to claim 6, wherein the ultra-thin film is obtained by applying a positive potential to a working electrode in an electrochemical cell including the working electrode and a counter electrode to perform the polymerization reaction between the aldehyde-based compound and the compound (A) capable of undergoing addition condensation with an aldehyde-based compound on the working electrode.

8. The ultra-thin film according to claim 6, wherein the compound (A) is a phenolic compound.

9. The ultra-thin film according to claim 6, wherein the ultra-thin film has a nanosized thickness.

10. The ultra-thin film according to claim 9, wherein the thickness is 10 to 800 nm.

11. A thermosetting resin obtained by performing a polymerization reaction between an aldehyde-based compound and a compound (A) capable of undergoing addition condensation with an aldehyde-based compound, wherein a density of the thermosetting resin is 0.2 to 0.7 g/cm³, and a Young's modulus of the thermosetting resin is 8 to 20 GPa.

12. The thermosetting resin according to claim 11, wherein the thermosetting resin has a net-like structure.

13. The thermosetting resin according to claim 11, wherein the compound (A) is a phenolic compound.

14. An ultra-thin film comprising the thermosetting resin according to claim 11.

15. The ultra-thin film according to claim 14, wherein the ultra-thin film has a nanosized thickness.

16. The ultra-thin film according to claim 15, wherein the thickness is 10 to 300 nm.

17. A composite thin film comprising the ultra-thin film according to claim 6, and one or more films selected from the group consisting of a nitrocellulose film, a nylon film, and a Teflon film.

18. A filtration membrane comprising the ultra-thin film according to claim 6 or the composite thin film according to claim 17.

19. A product for controlling bacteria and/or viruses comprising the ultra-thin film according to claim 6 or the composite thin film according to claim 17.

20. A carbonized film obtained by carbonizing the ultra-thin film according to claim 6.
